(19) United States
(12) Patent Application Publication
(10) Pub. No.: US 2021/0125141 A1
(43) Pub. Date: Apr. 29, 2021

(54) DATA ACQUISITION USING MACHINE-READABLE OPTICAL SYMBOLS

(71) Applicant: SNAP-ON INCORPORATED, Kenosha, WI (US)

(72) Inventors: Matthew J. LIPSEY, Sherwood, AR (US); David C. FLY, Maumelle, AR (US); Preston C. PHILLIPS, Conway, AR (US); Jason NEWPORT, Conway, AR (US); Cody L. HOUSTON, Conway, AR (US); Joseph CHWAN, Mechanicsburg, PA (US); Frederick J. ROGERS, North Little Rock, AR (US); Sean W. RYAN, Pleasant Prairie, WI (US)

(21) Appl. No.: 17/071,857

(22) Filed: Oct. 15, 2020

Related U.S. Application Data
(60) Provisional application No. 62/925,054, filed on Oct. 23, 2019.

(51) Int. Cl. G06Q 10/08; G06K 7/14; G06F 16/955

(52) U.S. Cl. CPC G06Q 10/087; G06F 16/9554; G06K 7/1417; G06K 7/1413

(57) ABSTRACT

An inventory control system comprises an object storage device, one or more processors, a display device, and a mobile device. The object storage device includes a plurality of compartments, and each compartment includes a plurality of storage locations for storing objects. The one or more processors are configured to establish a database containing information regarding the object storage device, retrieve the information regarding the object storage device from the database, and generate an optical symbol based on the information regarding the object storage device. The display device is associated with the object storage device and configured to display the optical symbol. The mobile device is configured to capture an image of the optical symbol, obtain the information regarding the object storage device based on the image of the optical symbol, and display the information regarding the object storage device on a display screen of the mobile device.

### RELATED APPLICATIONS

This application claims priority to U.S. provisional application No. 62/925,054, filed Oct. 23, 2019, the entire content of which is incorporated herein by reference.

### TECHNICAL FIELD

The present subject matter relates to automated tool control systems, and to techniques and equipment to managing automated tool control systems.

### BACKGROUND

When tools are used in a manufacturing or service environment, it is important that tools be returned to a storage unit, such as a tool box, after use. Some industries have high standards for inventory control of tools, for example, to prevent incidents of leaving tools in the workplace environment where the tools left behind could cause severe damage. In the aerospace industry, for instance, it is important to ensure that no tools are accidentally left behind in an aircraft or missile being manufactured, assembled, or repaired in order to prevent foreign object damage (FOD) to the aircraft.

Some toolboxes include built-in inventory determination features to track inventory conditions of tools stored in those toolboxes. For example, some toolboxes include contact sensors, magnetic sensors, or infrared sensors in or next to each tool storage location, to detect whether a tool is placed in each tool storage location. Based on signals generated by the sensors, the toolboxes are able to determine whether any tools are missing from the toolboxes.

While these toolboxes are typically robust and have low failure rates, failures can occur. Depending on the types of the failures, an operator or service technician on site may need to contact a remotely located technical support team. However, in order to correctly diagnose the cause of the failure and effectively address the failure, the technical support team may request basic system data of the toolbox, such as toolbox's model, serial number, and software version.

Currently, once the on-site operator or service technician locates the basic system data, the on-site operator manually records the basic system data or uses a camera to capture the screen image that includes the basic system data. The basic system data is then either transferred by voice over a phone to the technical support team or transcribed into an electronically transferrable format (e.g., emails, etc.) and sent to the technical support team.

However, transferring basic system data in the above-mentioned manner may be prone to errors. For example, the on-site operator may erroneously record the basic system data which tends to include alphanumeric sequences. The on-site operator then may convey the erroneously recorded basic system data to the technical support team.

Accordingly, there is a need for an improved system that enables the accurate transfer of basic system data of toolboxes from worksites to technical resources.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary automated tool control (ATC) system according to examples of the subject technology.

FIG. 2 illustrates an exemplary automated tool control system according to examples of the subject technology.

FIGS. 3A and 3B illustrate various exemplary tool control storage devices.

FIGS. 4A and 4B are exemplary embodiments of the tool control storage device according to examples in this disclosure.

FIGS. 5A-5C illustrate example user interfaces of the tool control storage device for locating the ATC system information in current ATC system according to this disclosure.

FIGS. 6A-6D illustrate examples of GUI including an icon or an image of a machine-readable optical symbol on the user interfaces of the tool control storage device according to subject technology.

FIG. 7 illustrates an exemplary smart tool system according to examples of the subject technology.

FIGS. 8A, 8B, 8C, 8D, 8E, and 8F illustrate various exemplary tool smart tools according to some embodiments in the disclosure.

FIG. 9 illustrates an exemplary overview of the communication between smart tools 706 and the central data server in the datacenter.

FIG. 10 conceptually illustrates an exemplary electronic system according to examples of the subject technology.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

To address the issues described in the Background, automated tool control systems have been developed which accurately transfer data, such as basic system data, via a network using machine-readable optical symbols. The various systems and methods disclosed herein relate to data acquisition using machine-readable optical symbols.

Reference now is made in detail to the examples illustrated in the accompanying drawings and discussed below.

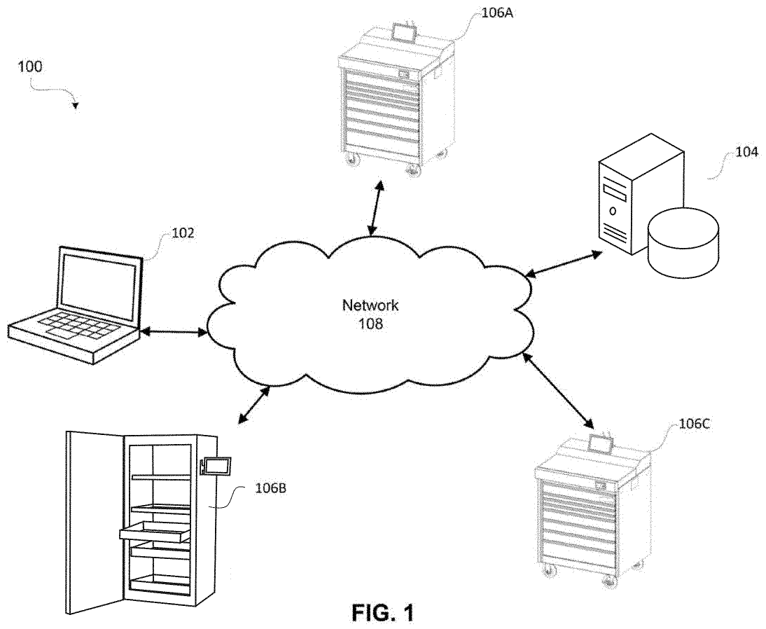

FIG. 1 illustrates an exemplary automated tool control (ATC) system 100 according to examples of the subject technology. The ATC system 100 includes a computing device 102, a database 104, tool control storage devices 106A, 106B, and 106C (hereinafter collectively referred to as “tool control storage devices 106”), and a network 108. In some aspects, the ATC system 100 can have more or fewer computing devices (e.g., 102), databases (e.g., 104), and/or tool control storage devices (e.g., 106A, 106B, and 106C) than those shown in FIG. 1.

The computing device 102 can represent various forms of processing devices that have a processor, a memory, and communications capability. The processor may execute computer instructions stored in a memory. The computing device 102 is configured to communicate with the database 104 and the tool control storage devices 106 via the network 108. By way of a non-limiting example, processing devices can include a desktop computer, a laptop computer, a handheld computer, a personal digital assistant (PDA), or a combination of any of these processing devices or other processing devices.

The computing device 102 may have applications installed thereon. For example, the applications may include an administrative client software application for automatically managing system user access data, item issue and return data, item status (i.e., lost, broken, calibration due, etc.).

The database 104 is a data storage for storing data associated with tools in the tool control storage devices 106 and the system users.

The tool control storage devices 106 (i.e., 106A, 106B, and 106C) each has a processor, a memory, and communications capability. The processor may execute computer instructions stored in memory. The tool control storage device 106 has a data link, such as a wired or wireless link, for exchanging data with the administrative client software application on the computing device 102 and the database 104. The tool control storage devices 106 transfer and receive data to and from the database 104 via the network.

The tool control storage device 106 is a toolbox in some embodiments. The tool control storage devices 106 may more generally be tool lockers or any other secure storage devices or enclosed secure storage areas (e.g., a tool crib or walk-in tool locker). Each of the tool control storage devices 106 is an example of a highly automated inventory control system that utilizes multiple different sensing technologies for identifying inventory conditions of objects in the storage unit. In one example, the tool control storage devices 106 use machine imaging or RF sensing methodologies for identifying inventory conditions of objects in the storage unit.

Illustrative features include the ability to process complex image data with efficient utilization of system resources, autonomous image and camera calibrations, identification of characteristics of tools from image data, adaptive timing for capturing inventory images, efficient generation of reference data for checking inventory status, autonomous compensation of image quality, etc. Further features include the ability to emit and receive RF sensing signals such as RF identification (RFID) signals, to process the received signals to identify particular tools, and to cross-reference tool information obtained through the multiple different sensing modalities (e.g., camera and RFID based modalities) to provide advanced features.

The network 108 may include wired or wireless connections. The network 108 allows the computing device 102, the database 104, and the tool control storage devices 106 to communicate with one another. For example, the network 108 may include a LAN, a WAN, or an Intranet, or a network of networks, for example, the Internet.

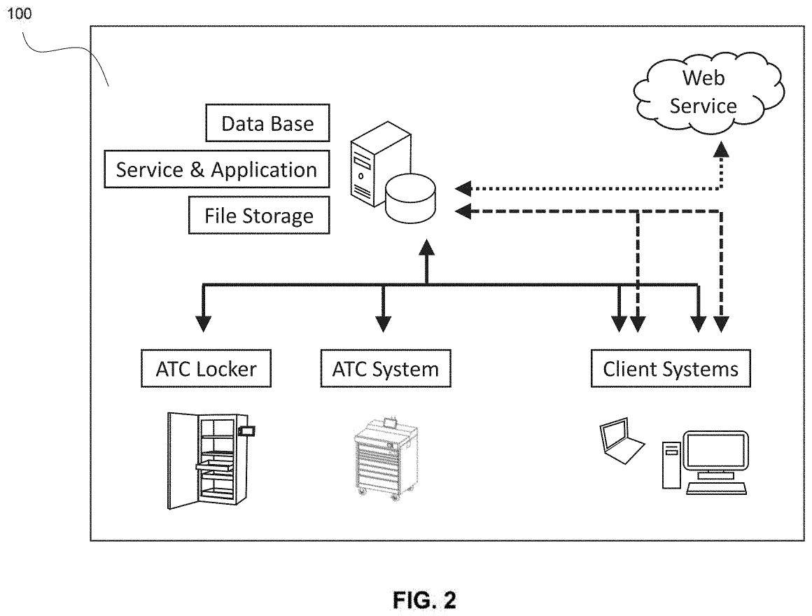

FIG. 2 illustrates an exemplary automated tool control system 100 according to examples of the subject technology. Customer Client Systems of FIG. 2 may correspond to the computing device 102 of FIG. 1. Database in FIG. 2 may correspond to the database 104 of FIG. 1. Automated Tool Control (ATC) Locker and ATC System of FIG. 2 may correspond to the tool control storage devices 106 of FIG. 1. Specifically, FIG. 2 illustrates detailed examples of the operating systems that may be used by the computing device 102, the database 104, and tool control storage devices 106, and the connections that may be used by the computing device 102, the database 104, and tool control storage devices 106 to communicate with one another.

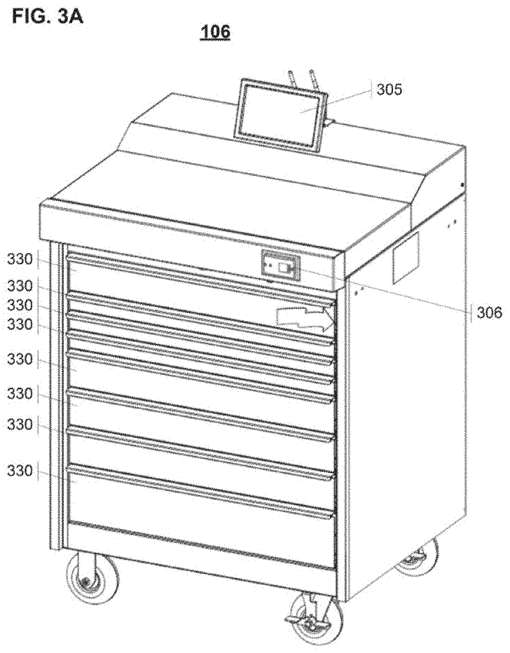

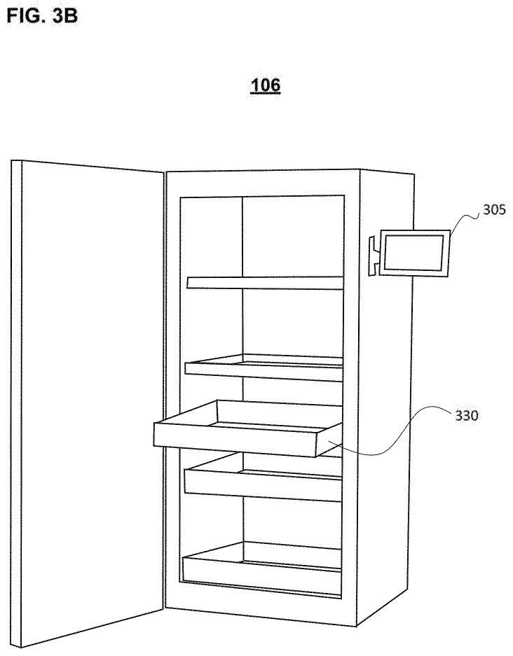

FIGS. 3A and 3B illustrate various exemplary tool control storage devices 106. FIG. 3A illustrates a drawer-type tool control storage device 106 that includes a user interface 305, an access control device 306, such as a card reader, for verifying identity and authorization levels of a user intending to access tool control storage device 106, and multiple tool storage drawers 330 for storing tools. Instead of drawers 330, the tool control storage device 106 may include shelves, compartments, containers, or other object storage devices from which tools or objects are issued and/or returned, or which contain the storage device from which the objects are issued and/or returned. In further examples, the tool control storage device 106 includes storage hooks, hangers, toolboxes with drawers, lockers, cabinets with shelves, safes, boxes, closets, vending machines, barrels, crates, and other material storage means. FIG. 3B illustrates a locker-type tool control storage device 106.

The user interface 305 is an input and/or output device of the tool control storage device 106, configured to display information to a user. Information may include work instructions, tool selection, safety guidelines, torque settings, system and tool status alerts and warnings. For instance, the user interface 305 may be configured to display the information in text strings and images in the default language assigned to the user who currently has access to the tool control storage device 106. Although not illustrated in FIGS. 2A and 2B, the tool control storage device 106 may include speakers as another output device of the tool control storage device 106 for outputting the information.

The access control device 306 authenticates a user's authorization for accessing ATC system 100. Specifically, the access control device 306 is used to limit or allow access to the tool storage drawers 330. The methods and systems used to electronically identify the user requesting access may include any one or more of the following technologies, and others not mentioned, individually or in combination: RFID proximity sensors with cards; magstripe cards and scanners; barcode cards and scanners; common access cards and readers; biometric sensor ID systems, including facial recognition, fingerprint recognition, handwriting analysis, iris recognition, retinal scan, vein matching, voice analysis, and/or multimodal biometric systems.

The access control device 306, through the use of one or more electronically controlled locking devices or mechanisms which may respond to voltage signals relating to unlock/lock commands, keeps some or all the storage drawers 330 locked in a closed position until the access control device 306 authenticates a user's authorization for accessing the tool control storage device 106. If the access control device 306 determines that a user is authorized to access the tool control storage device 106, it unlocks some or all of the storage drawers 330, depending on the user's authorization level, allowing the user to remove or replace tools. In particular, the access control device 306 may identify predetermined authorized access levels to the system, and allow or deny physical access by the user to the three dimensional space or object storage devices based on those predetermined authorized levels of access.

The tool control storage device 106 includes several different sensing subsystems. In an illustrative example, the tool control storage device 106 includes a first sensing subsystem in the form of an image sensing subsystem configured to capture images of contents or storage locations of the system. The image sensing subsystem may include lens-based cameras, CCD cameras, CMOS cameras, video cameras, or any types of devices that captures images. The tool control storage device 106 may further include a second sensing subsystem that, in one example, takes the form of an RFID sensing subsystem including one or more RFID antennas, RFID transceivers, and RFID processors. The RFID sensing subsystem is configured to emit RF sensing signals, receive RFID signals returned from RFID tags mounted on or incorporated in tools or other inventory items in response to the RF sensing signals, and process the received RFID signals to identify individual tools or inventory items.

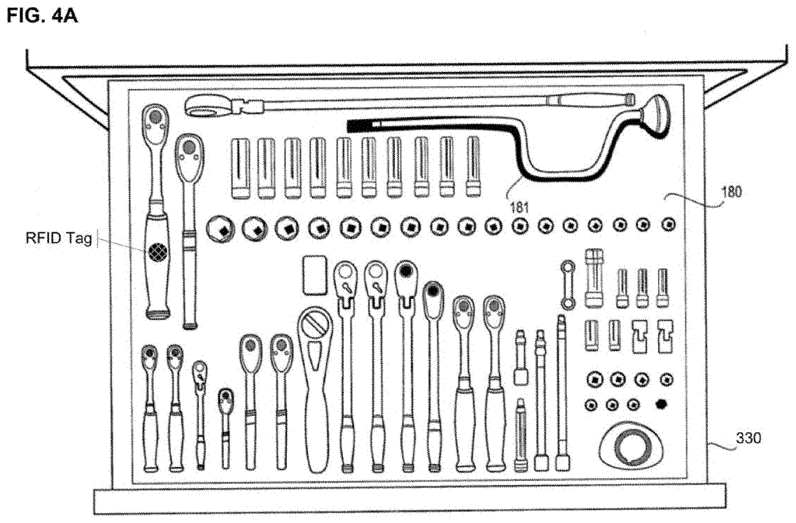

While FIGS. 4A and 4B correspond to a specific embodiment of the tool control storage device 106 shown in FIG. 1, the teachings illustrated in FIGS. 4A and 4B can be applied to each of the embodiments of FIG. 1. FIG. 4A shows a detailed view of one drawer 330 of the tool control storage device 106 in an open position. The image sensing subsystem is described in further detail below in relation to FIG. 4B.

In some embodiments, as illustrated in FIG. 4A, each storage drawer 330 includes a foam base 180 having a plurality of storage locations, such as tool cutouts 181, for storing tools. Each cutout is specifically contoured and shaped for fittingly receiving a tool with a corresponding shape. Tools may be secured in each storage location by using hooks, Velcro, latches, pressure from the foam, etc. In general, each storage drawer 330 includes multiple storage locations for storing various types of tools. As used throughout this disclosure, a storage location is a location in a storage system for storing or securing objects. In one embodiment, each tool has a specific pre-designated storage location in the tool storage system.

Further, one or more tools in the drawer 330 may have an RFID tag mounted or attached thereon. The RFID sensing subsystem may be configured to sense RFID tags of tools located in all the storage drawers 330 of the tool control storage device 106, or configured to sense RFID tags of tools located in a particular subset of the drawers 330 of the tool control storage device 106. The tool control storage device 106 further includes a data processing system, such as a computer, for processing images captured by the image sensing device, for processing RFID signals captured by the RFID antennas and transceivers, and/or for processing other sensing signals received by other sensing subsystems.

The RF sensing subsystem is generally configured to perform inventory checks of drawers or shelves having RF-based tags associated therewith. The RF-based tags may be RFID tags that are attached to or embedded within the tools. In general, the RF-based tag encodes an identifier unique to the tool, such that both the tool type (e.g., screwdriver, torque wrench, or the like) and the unique tool (e.g., a particular torque wrench, from among a plurality of torque wrenches of the model and type) can be identified from reading the RF-based tag. In particular, the information encoded in the RF-based tag is generally unique to the tool such that it can be used to distinguish between two tools that are of a same type, same model, same age, same physical appearance, etc.

The RF sensing system includes antennas mounted in or around the tool control storage device 106. In general, the antennas may be mounted inside the tool control storage device 106 and be configured to only detect the presence of RF-based tags that are located within the tool control storage device 106 (or other defined three dimensional space). In some examples, each antenna may be mounted so as to only detect the presence of RF-based tags that are located within a particular drawer or compartment of the tool control storage device 106, and different antennas may be associated with and mounted in different drawers or compartments. In further embodiments, some antennas may further be configured to detect the presence of RF-based tags in the vicinity of the tool control storage device 106 even if the tags are not located within the tool control storage device 106.

Each antenna is coupled to an RF transceiver that is operative to cause the antenna to emit an RF sensing signal used to excite the RF-based tags located within the vicinity of the antenna, and is operative to sense RF identification signals returned by the RF-based tags in response to the RF sensing signal. One or more RF processors control the operation of the RF transceivers and process the RF identification signals received through the antennas and transceivers.

In some embodiments, the RF sensing subsystem performs an RF-based scan of the tool control storage device 106 when a drawer or compartment storing tools having RF identification tags is completely closed. In particular, the RF-based scan can be performed in response to detecting that the drawer has been completely closed, or performed at any time when the drawer is completely closed. In some examples, the RF-based scan can also be triggered by a user logging into or logging out of the tool control storage device 106. In general, an RF-based scan can be performed in response to similar triggers causing a camera-based inventory of the tool control storage device 106 to be performed.

FIG. 4B shows a perspective view of an imaging subsystem in the tool control storage device 106 according to an embodiment. As illustrated in FIG. 3B, the tool control storage device 106 includes an imaging compartment 315 which houses an image sensing subsystem comprising three cameras 310 and a light directing device, such as a mirror 312 having a reflection surface disposed at about 45 degrees downwardly relative to a vertical surface, for directing light reflected from the drawers 330 to the cameras 310. The directed light, after arriving at the cameras 310, allows the cameras 310 to form images of the drawers 330. The shaded area 340 below the mirror 312 represents a viewing field of the imaging sensing subsystem of the tool control storage device 106. As shown at 340, the imaging subsystem scans a portion of an open drawer 336 that passes through the field of view of the imaging sensing subsystem, for example as the drawer 336 is opened and/or closed. The imaging subsystem thereby captures an image of at least that portion of the drawer 336 that was opened. Processing of the captured image is used to determine the inventory conditions of tools and/or storage locations in the portion of the drawer 336 that was opened.

In general, the image sensing subsystem captures an image of a particular drawer 330 and performs an inventory of the drawer in response to detecting movement of the particular drawer. For example, the image sensing subsystem may perform an inventory of the drawer in response to detecting that the drawer is closing or has become completely closed. In other examples, the image sensing subsystem may image the drawer both as it is opening and as it closes.

The data processing system includes one or more processors (e.g., micro-processors) and memory storing program instructions for causing the tool control storage device 106 to communicate electronically directly or through a network with sensing devices and obtain data from sensing devices relative to the presence or absence of objects within the three dimensional space or object storage device. Images, RFID signals, and other sensing signals captured or received by the sensing subsystems are processed by the data processing system for determining an inventory condition of the system or each storage drawer. The term inventory condition as used throughout this disclosure means information relating to an existence/presence or non-existence/absence condition of objects in the storage system.

Based on the RFID sensing system and the image sensing system present in the tool control storage device 106, a cross-check may be performed between the results of the RFID-based inventory scan and the image-based inventory scan to ensure that the results of the two scans are consistent. Specifically, the inventory cross-check is performed to ensure that both inventory scans have identified the same tools as being present in the tool control storage device 106 and have identified the same tools as being absent from the tool control storage device 106. User alerts are issued if the results of the two inventory scans are not consistent with each other.

Other sensing systems used in inventory of the tool control storage device 106 may include:
Optical identification sensors, such as: sensors for detecting one dimensional barcodes with line scanner/camera; sensors for detecting two dimensional barcodes with camera/other imaging sensor; machine vision identification sensors with camera/other imaging sensor (using various sensing approaches, including UV, infrared (IR), visible light, or the like); and laser scanning;
RF identification sensors, such as: RFID tags affixed to/embedded in tools (active RFID tags and/or passive RFID tags); other RF technologies used in similar capacity, such as Ruby, Zigbee, WiFi, NFC, Bluetooth, Bluetooth lower energy (BLE), or the like;
Direct electronic connection to tool, such as: tools that have attached/embedded connectors that plug into identification system (as opposed to wireless);
Weight sensor(s), such as: scales to detect weight of objects; multiple scales to detect weight distribution;
Contact switches/sensors, such as: single go/no-go sensors; array of sensors to detect shape/outline;
Sonic emitter/detector pair; and/or
Magnetic induction/sensing, such as ferrous tool locator products.

The ATC system 100 allows the operators to operate the ATC system 100 via the user interface 305 of the tool control storage device 106. For example, a graphical user interface (GUI) displayed on the user interface 305 provides information and process flows requested by the operator so that the operator may complete the desired transactions. Although the GUIs are generally intuitive and user friendly, more technical skill and knowledge may be required to successfully and seamlessly navigate to and initiate some advanced features of the ATC system 100, such as configuration screens and diagnostic functions.

Service manuals and User/Operations guides may provide guidance for completing the advanced features of the ATC system 100. The Service manuals and User/Operations guides may be available via printed form and/or digital form on websites. In many instances, the situations that require manipulation of the advanced features of the ATC system 100 require immediate attention, for example, having the operator search for the printed form of the manuals and guides or having the operator search for the manuals and guides on a web browser on a computing device may be cumbersome and take time for the operator. Instead, the operator may choose to contact a technical support team to help resolve the situations.

When the operator contacts a technical support team, a technical support representative from the technical support team may request data and information specific to the ATC system 100. The data and information specific to the ATC system 100 may include (1) basic ATC system information, which may be gathered from a database and applications installed on the components of the ATC system 100, and (2) advanced ATC system information.

The basic ATC system information associated with the tool control storage device 106 may include a box name (e.g., storage device name), a box ID (e.g., identification of the storage device), a device serial number, an ATC software version, an ATC service machine, the last logged user, etc.

The advanced ATC system information associated with the tool control storage device 106 may include an Internet Protocol (IP) address of the tool control storage device 106, a wireless-fidelity (Wi-Fi) service set identifier (SSID), a Wi-Fi signal strength, an ATC service name, customer information, a business name, contact information, active alerts/alarms, battery/power status, warranty information, product and accessory license data, component configuration (e.g., sensing subsystems), a model of the tool control storage device 106, serial number, a hardware version, a firmware version, other software versions, a hop table configuration (for RFID sensing system only), camera calibration factors (for image sensing system only), online with service (yes/no), etc.

The operators may require instructions for processes and procedures on the tool control storage device 106 including, for example, tool searches, box audit, drawer training, tool tolerance adjustments, date/time adjustments, touch screen calibrations, battery level display, tool status adjustment (e.g., assigning and/or clearing tool status), calibration and inspection due date setting, tool retraining, locating tools, etc.

While the ATC systems are typically robust and have low failure rates, failures can occur. Depending on types of the failures, even properly trained on-site operators with the manuals and guides on the ATC system may have difficulty collecting necessary system data to diagnose the cause of the failure. If the cause of the failure is not easily diagnosed, the on-site operators may need to contact a remotely located technical support team to report the issue and request repair instructions on the ATC system 100.

In order to correctly diagnose the cause of the failure and effectively address the root cause of the failure, the technical support team may request the ATC system information from the on-site operator. However, the ATC system information required to properly diagnose the problem and effectively resolve the problem may not be readily available to the on-site operator.

The diagnostics information on the ATC system 100 required to properly diagnose the cause of the failure and effectively resolve the failure may be obtained by the on-site operator logging onto the ATC system 100 using the user interface 305 of the tool control storage device 106 or using the GUI of the administrative client software application on the computing device 102. The on-site operator may then search through different screens or tabs to find data of the ATC system 100 required for diagnosing the cause of the failure.

Once the on-site operator locates the page or tab that includes the data of the ATC system 100 required for diagnosing the cause of the failure, the on-site operator may manually record the data of the ATC system 100 displayed on the user interface 305 of the tool control storage device 106 or the GUI of the administrative client software application on the computing device 102. The on-site operator may also capture, using an imaging device (e.g., camera), the screen image of the user interface 305 or the GUI of the administrative client software application that contains the data of the ATC system 100. When the data of the ATC system 100 is recorded, the recorded data of the ATC system 100 may be verbally communicated over a phone to the technical support team or may be manually transcribed into an electronically transferrable format, such as email, and transmitted to the technical support team.

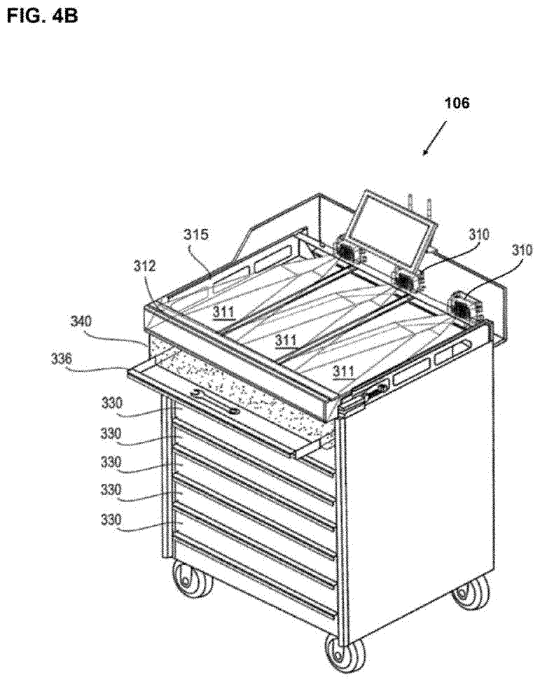

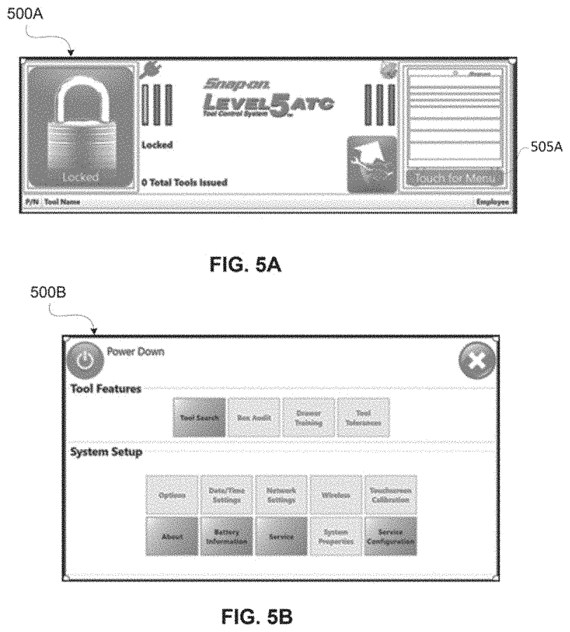

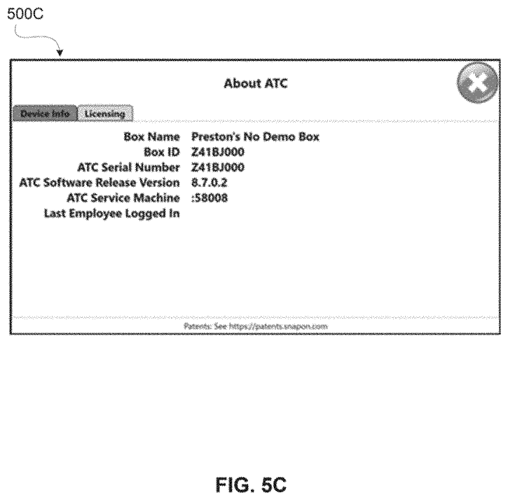

In some instances, the on-site operator may be required to locate ATC system information on the tool control storage device 106. FIGS. 5A-5C illustrate example user interfaces 305 of the tool control storage device 106 for locating the ATC system information in current ATC system. FIG. 5A illustrates an exemplary GUI 500A of the tool control storage device 106. The GUI 500A includes a menu icon 505A for navigating the on-site technician to a menu page. When the on-site operator logs onto the ATC system 100 via the user interface 305 of the tool control storage device 106, the on-site operator selects the menu icon on the GUI to navigate to a menu page.

FIG. 5B illustrates another exemplary GUI 500B of the tool control storage device 106. Specifically, the GUI 500B illustrated in FIG. 5B corresponds to the menu page launched when the on-site operator selected the menu icon 505A of FIG. 5A. The menu page includes, for example, icons associated with tool features for tools stored in the tool control storage device 106 and icons associated with system setup of the tool control storage device 106. The on-site operator may select an “About” icon within the menu page to display the ATC system information of the tool control storage device 106.

The icons associated with the tool features may include, for example, “Tool Search” for searching tools on the ATC system 100, “Box Audit” for checking inventory of the tool control storage device 106, “Drawer Training” for training the ATC system 100 to learn about the tools to be stored in certain drawers of the tool control storage device 106, and “Tool Tolerances” for setting calibration and/or replacement due for the tools stored in the tool control storage devices 106. The icons associated with the tool features may include less than or more than the numbers of icons illustrated in FIG. 5B.

The icons associated with the system setup may include, for example, “Options” for setting user preferences on the tool control storage device 106, “Date/Time Settings” for setting date/time or setting user preferences on the date/time on the tool control storage device 106, “Network Settings” for setting network parameters for the tool control storage device 106, “Wireless” for displaying information related to the wireless network of the tool control storage device 106, “About” for displaying basic ATC system information, “Battery Information” for checking the battery status or displaying information related to the battery of the tool control storage device 106, “Services” for displaying the information related to the services for the tool control storage device 106, “System Properties” for displaying information related to the tool control storage device 106, and “Service Configuration” for displaying the service configuration for the tool control storage device 106. The icons associated with the system setup may include less than or more than the numbers of icons illustrated in FIG. 5B.

FIG. 5C illustrates an “About” page 500C that includes the basic ATC system information. The ATC system information of the tool control storage device 106 may include, for example, the box name (e.g., name of the tool control storage device 106), the box ID (e.g., identification of the tool control storage device 106), the ATC Serial Number (e.g., device serial number for the tool control storage device 106), the ATC Software Release Version (e.g., version of the software installed on the tool control storage device 106), the ATC Service Machine, and the last employee who logged into the ATC system.

The on-site operator may manually record the ATC system information displayed on the “About” page or take a screen image of the “About” page. Then, the on-site operator may transfer the ATC system information over a phone or via electronic messages to the technical support team for diagnosing the cause of the failure.

Not only is manually recording and transferring the ATC system information time consuming and cumbersome for the on-site operator, manually recoding and transferring the ATC system information may also be prone to errors. For example, the on-site operator may erroneously record the ATC system information which tends to include alphanumeric sequences. The on-site operator may convey the erroneously recorded ATC system information to the technical support team. In another example, the on-site operator may provide a screen image of the ATC system information to the technical support team via electronic messaging system. Although the ATC system information may be accurately provided from the on-site operator to the technical support team, the technical support team which received the screen image may need to manually enter the ATC system information into the system creating a risk of erroneously entering the ATC system information.

To reduce the burden on the on-site operator and minimize the errors, a machine-readable optical symbol may be used to transmit necessary information from the on-site operator to the remote technical support team. For example, an icon or an image of a machine-readable optical symbol may be embedded on each GUI screen.

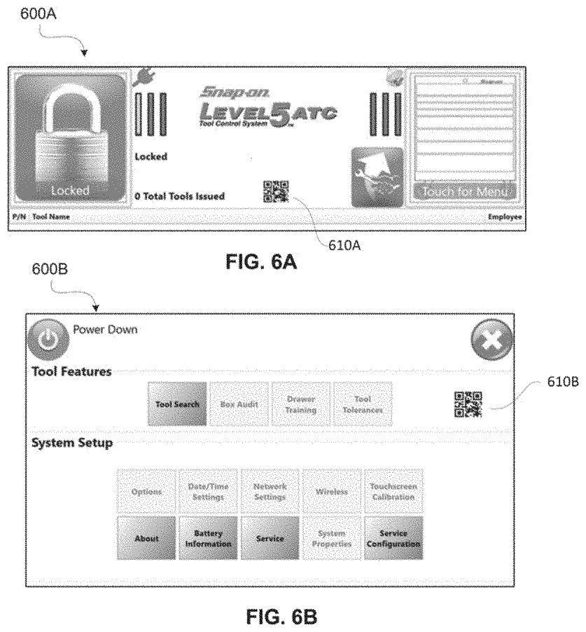

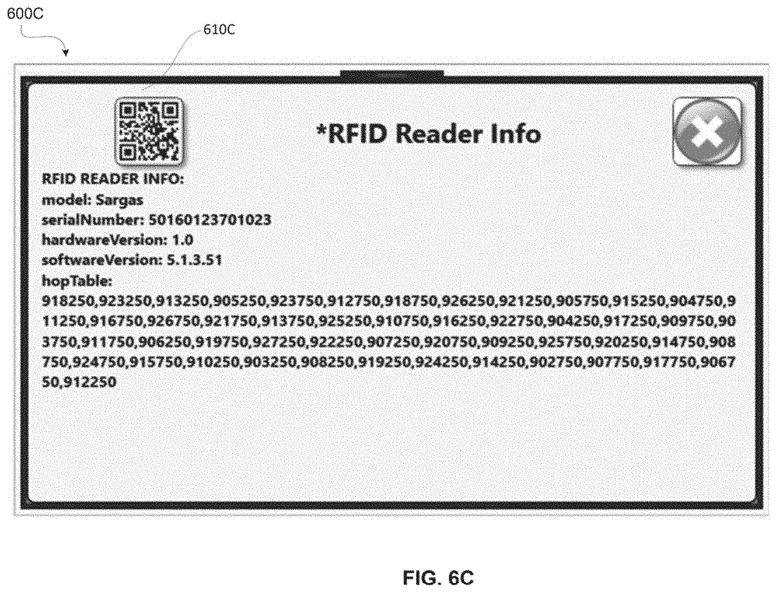

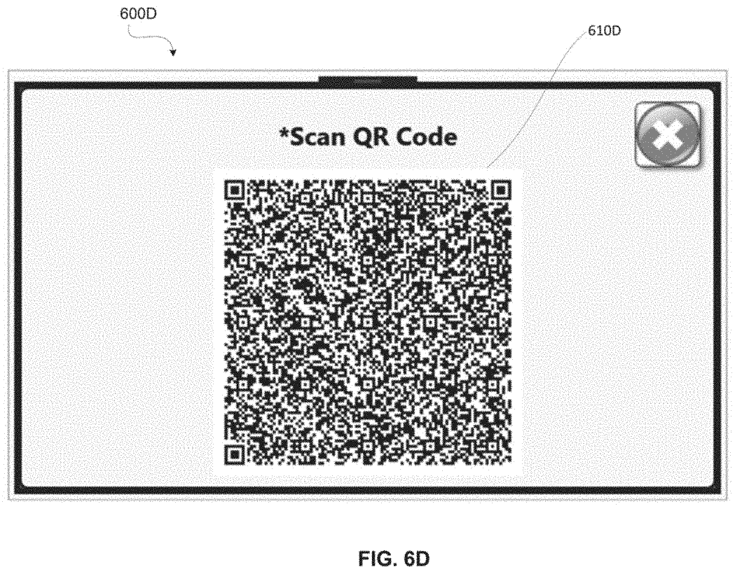

FIGS. 6A-6D illustrate examples of GUI including an icon or an image of a machine-readable optical symbol on the user interfaces 305 of the tool control storage device 106 according to subject technology. FIGS. 6A-6C respectively include GUI 600A-600C that respectively include machine-readable optical symbol icons 610A-610C. FIG. 6D includes a GUI 600D that includes a machine-readable optical symbol image 610D.

When a touch or a user selection is received at the displayed icon of the machine-readable optical symbol as illustrated in FIGS. 6A-6C, software installed on the ATC system 100 gathers information regarding the tool control storage device 106 and encodes the gathered information regarding the tool control storage device 106. The software creates a machine-readable optical symbol storing the encoded information.

The software may gather the information to be encoded and stored in the machine-readable optical symbol from a GUI page that is currently displayed on the user interface 305 of the tool control storage device 106. In some embodiments, the software may gather the information to be encoded and stored in the machine-readable optical symbol from multiple sources on the ATC system 100. In some embodiments, data may be pre-stored in a machine-readable optical symbol. The pre-stored data may include, for example, instructions, procedures, images, messages, links, and other data related to the function or process available within the GUI displayed on the user interface 305. In some embodiments, a machine-readable optical symbol may be automatically created. Once a machine-readable optical symbol is created, the machine-readable optical symbol may be displayed on the GUI screen as illustrated in FIG. 6D.

A machine-readable optical symbol may include a two-dimensional (2D) bar code, a Quick Response (QR) code, a portable data file 417 (PDF417), a Data Matrix, an Aztec Code, a Maxi Code, or any other 2D format. In some embodiments, topographic or colorful three-dimensional (3D) barcodes may be used in place of 2D barcodes. 3D barcodes may allow direct storage and transmission of large amounts of data from an ATC system to a mobile device. For example, 3D barcodes allows transfer and display of service and training videos, entirety of user manuals and/or service manuals along with parts lists, and other data intensive applications and documents.

The operator may scan the displayed machine-readable optical symbol using a mobile device. A mobile device may include a mobile phone, a smart phone, a tablet, or any other portable devices equipped with a camera for capturing the displayed machine-readable optical symbol and a function to decode the encoded information stored in the captured machine-readable optical symbol. For example, the mobile device may be equipped with application software that provides functions of decoding the encoded data stored in the machine-readable optical symbol. The decoded information may be provided for display on a screen of the mobile device.

In an embodiment, QR codes may be used as the machine-readable optical symbol. Some pages to be displayed in the GUI for the tool control storage device 106 are QR enabled. For example, those pages may include embedded QR code icons. When a QR code icon embedded in a page being displayed in the GUI is selected, the ATC system 100 may generate a QR code for a pre-stored data set specific to the QR enabled page. The device GUIs may include a number of QR enabled pages, and the pre-stored data used to generate a QR code may be specific to each individual page. For example, pre-stored data may include instructions, procedures, images, messages, links, and other data related to the function or process available within the GUI displayed on the user interface 305.

Once the QR code is created for the page displayed on the device GUI display, the displayed QR code may be scanned using a mobile device, such as a smart phone. The mobile device may be equipped with a QR decoding application. When the QR decoding application scans the QR code, the QR decoding application may decode the data stored in the QR code and display the decoded data on the device display of the mobile device. The user can then use this information in configuration, operation, or diagnosis and repair of the ATC device or system.

In place of creating a QR code in response to receiving a user selection at the QR code icon in the page, the ATC system may be set so that a standard QR code is created during the initial system set up and configuration, and the QR code may contain system information and data that does not change over time. The QR code created during the initial system setup can be invoked at any time when a user selection is received at a QR icon located on an easily accessible page such as the Dashboard or the About screen of the tool control storage device 106.

In another embodiment, the methods of creating a QR code are similar to the above embodiment, except the data for each QR enabled page is not pre-stored data. In this embodiment, the ATC system 100 may be equipped with software that searches through the database associated with the tool control storage device 106 or the ATC system 100 and event files to locate and encode device and system information required to create a QR code with data relative to the originating QR enabled GUI page. That is, when the QR icon displayed in the screen (i.e., user interface 305) receives a user selection, the software is invoked, and an encoded QR code image is created using data resulting from a system search of data relative to the originally displayed screen.

In another embodiment, in addition to creating a QR code in the tool control storage device 106 and displaying the QR code on the screen (i.e., user interface 305) of the tool control storage device 106, the QR code may be transferred through the network (i.e., network 108) to the administration client software application on the computing device 102 and displayed on a screen of the computing device 102.

Alternately, the data used to generate the QR code may be transferred through the network 108 to the administration client software application on the computing device 102. The administration client software application may convert the transferred data into a QR code (generate a QR code based on the transferred data) and provide the QR code for display on the screen of the computing device 102. This alternative method may be useful if the on-site operator does not have access to a mobile device. This function may be reserved as a customer preference for the administrator of the ATC system 100, and therefore, the QR code needs to be displayed on the screen of a computing device (e.g., screen of the computing device 102) that the administrator have generally access the ATC system from.

In some embodiments, a networked ATC system (e.g., ATC system 100) may be connected to the Internet and or also “Cloud” services, such as Amazon Web Services.

The tool control storage device 106 may be equipped with a dedicated QR enabled GUI display page that generates a QR code containing the complete data set necessary to open a service ticket on a web based service application. For example, when an on-site operator may invoke a service call page on the screen of the tool control storage device 106, the tool control storage device 106 generates an “Open a service call” QR code. When the on-site operator scans the resulting “Open a service call” QR code displayed on the screen with a mobile device, the mobile device decodes the data from the “Open a service call” QR code and recognizes the specific “open a service ticket” code within the decoded data. The specific “open a service ticket” code facilitates the mobile device to connect to the web based Service application and to upload the data set necessary to open the Service ticket to the Service application. When the Service application accepts the uploaded data, the service ticket is opened, and a service technician from the technical team may be dispatched to repair the tool control storage device 106 or other devices within the ATC system 100.

Upon arrival at the site, the service technician can record a date and time stamp using the same process for opening a service ticket. Recording of the date and time stamp may trigger closing the service ticket with a repair completed QR code.

As described above, toolboxes that include built-in inventory determination features to track inventory conditions of tools stored in those toolboxes are typically robust and have low failure rates. Similar to these toolboxes, tools to be stored in these toolboxes are also typically robust and have low failure rates. However, in addition to regular maintenance (e.g., calibration, parts replacements, etc.), failures require support from a remotely located technical support team can occur in these tools.

In order for the technical support team to perform the correct maintenance or to correctly diagnose the cause of the failure and effectively address the failure, basic data of the tool, such as the tool's model, serial number, and software version may need to be accurately transferred the technical support team.

To improve the accurately transferring the basic data of the tools to the technical support team, tools have been developed which accurately transfer data, such as basic system data, via a network using machine-readable optical symbols.

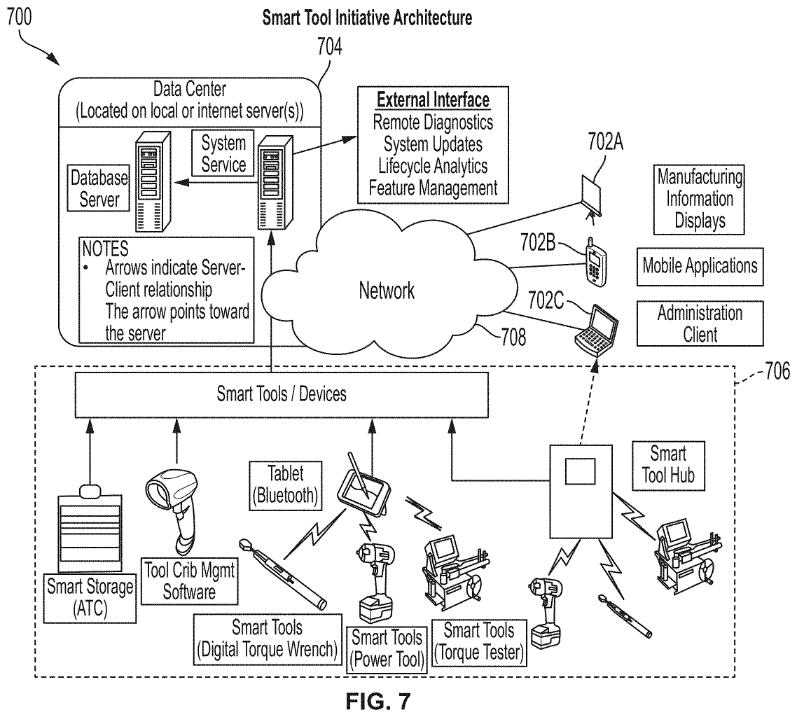

FIG. 7 illustrates an exemplary smart tool system 700 according to examples of the subject technology. The smart tool system 700 includes computing devices 702A, 702B, and 702C (hereinafter collectively referred to as “computing devices 702”), a datacenter 704, a group of smart tools/devices 706 (e.g., smart tools, smart storages (e.g., ATC), tool crib management software, etc.), and a network 708. In some aspects, the smart tool system 700 can have more or fewer computing devices (e.g., 702), datacenter (e.g., 704), and/or a group of smart tools/devices (e.g., 706) than those shown in FIG. 7.

The computing devices 702 can represent various forms of processing devices that have a processor, a memory, and communications capability. The processor may execute computer instructions stored in a memory. The computing devices 702 are configured to communicate with the datacenter 704 via the network 708. The computing devices 702 are also configured to communicate with smart tools using a smart tool hub via a network. By way of a non-limiting example, processing devices can include a desktop computer, a laptop computer, a handheld computer, a personal digital assistant (PDA), or a combination of any of these processing devices or other processing devices.

The computing devices 702 may have applications installed thereon. For example, the applications may include an administrative client software application for automatically managing system user access data, item issue and return data, tool status (i.e., lost, broken, calibration due, etc.).

The datacenter 704 may include data storages for storing data associated with smart tools 706, system users, and system services.

The smart tools 706 may include tools, such as digital torque wrenches, torque testers, power tools, smart storages (e.g., ATC), and tool crib management software for tool cribs. Each of the smart tools has a processor, a memory, and communications capability. The processor may execute computer instructions stored in memory. The smart tools 706 have a data link, such as a wired or wireless link, for exchanging data with smart tool hubs and/or tablets that relays data to and from the administrative client software application on the computing device 702 and the datacenter 704 via the network. In some embodiments, the smart tools 706 may exchange data directly with the administrative client software application on the computing device 702 and the datacenter 704 via the network.

The network 708 may include wired or wireless connections. The network 708 allows the computing device 702, the datacenter 704, and the smart tools 706 to communicate with one another. For example, the network 708 may include a LAN, a WAN, or an Intranet, or a network of networks, for example, the Internet. Further, the smart tools may connect to smart tool hubs and tablets via, for example, a Bluetooth network.

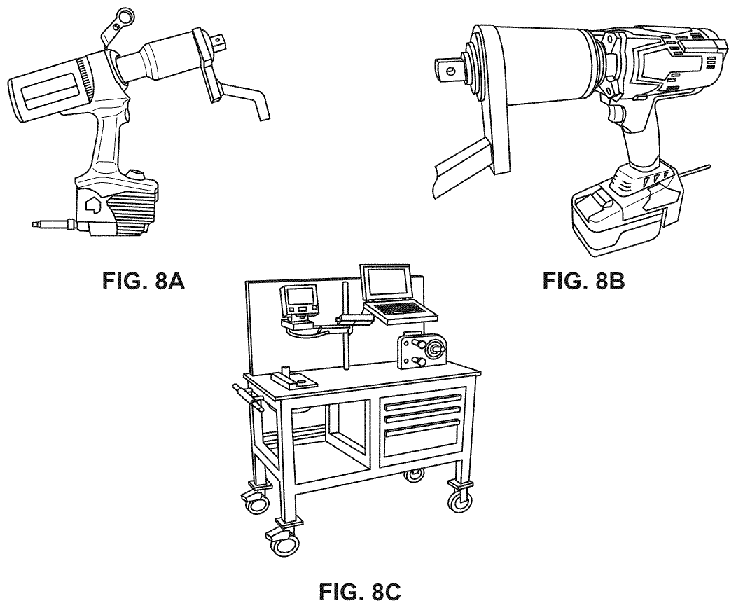

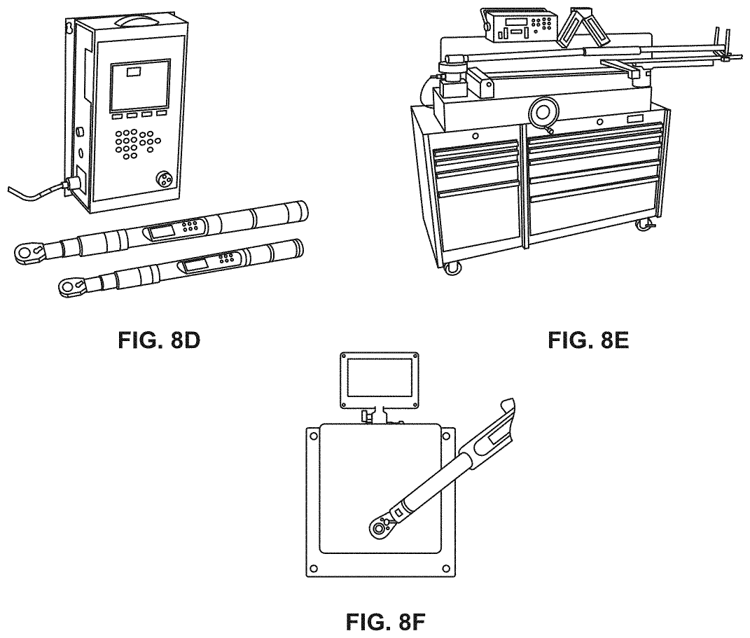

FIGS. 8A, 8B, 8C, 8D, 8E, and 8F illustrate various exemplary tool smart tools 706. FIG. 8A illustrates a power tool that includes the smart tool functions that allow the power tool to communicate with the administrative client software application on the computing device 702 and the datacenter 704 via the network. The power tool may communicate with the administrative client software application through smart tool hubs and/or tablet. FIG. 8B illustrates a power tool seen from another perspective.

FIG. 8C illustrates a calibration station for calibrating tools. The calibration station may include the smart tool functions that allow the calibration station to communicate with the administrative client software application on the computing device 702 and the datacenter 704 via the network. FIG. 8D illustrates a set of digital torque wrenches and a smart tool hub. The set of digital torque wrenches may have the smart tool functions. Further, the smart tool hub may allow smart tools, such as digital torque wrenches and power tools to communicate with the administrative client software application on the computing device 702 and the datacenter 704 via the network.

FIG. 8E illustrates an electric torque tester and calibrator that communicates with the administrative client software application on the computing device 702 and the datacenter 704 directly or indirectly through the smart hub and/or portable devices (tablets, smart phones, etc.). FIG. 8F illustrates a torque tester that has the smart function to communicate with the administrative client software application on the computing device 702 and the datacenter 704 directly or indirectly through the smart hub and/or portable devices (tablets, smart phones, etc.).

The various smart tools illustrated in FIGS. 8A-8F may include displays, and may be equipped with a processors and memories for generating machine-readable optical symbols to be displayed on the displays. In some embodiments, smart tool hubs and tablets connected to the smart tools may be used to generate machine-readable optical symbols and display the generated machine-readable optical symbols on displays of the smart tool hubs and tables on behalf of the connected smart tools.

Generating and displaying machine-readable optical symbols on the smart tools 706 allows basic information of the smart tool that require attention to be accurately transferred to the remotely located technical support team. In some embodiments, as described in FIGS. 6A-6D, information regarding the smart tool 706 may be gathered and encoded. A machine-readable optical symbol storing the encoded information may be created and displayed on the display. Since the configuration for gathering and encoding information of the smart tool 706 and generating and displaying the machine-readable optical symbol are substantially the same as the description of FIGS. 6A-6D, the description thereof is omitted herein.

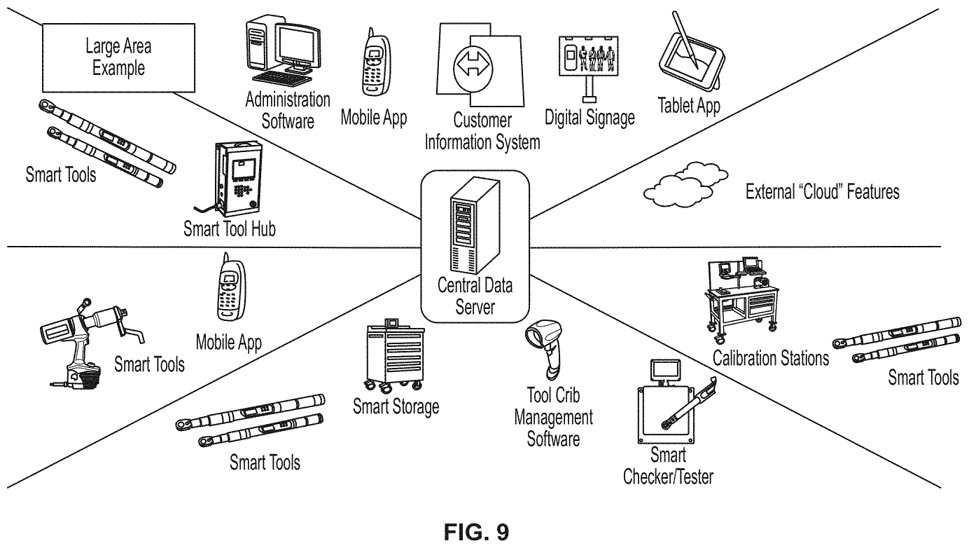

FIG. 9 illustrates an exemplary overview of the communication between smart tools 706 and the central data server in the datacenter 704. For example, smart tools 706 may communicate with the central data server in the datacenter 704 through smart tool hubs. In another example, the smart tools 706 may communicate with the central data server in the datacenter 704 through mobile applications on mobile devices (e.g., tablets, smart phones, etc.). In yet another example, smart tools 706 may communicate with the central data server in the datacenter 704 using calibration stations (e.g., electronic calibrator, electronic tester and calibrator).

The smart tools 706 may further communicate with the central data server in the datacenter 704 through toolboxes (e.g., ATC 106) and tool crib management software. In some embodiments, the smart tools 706 may directly communicate with the central data server in the datacenter 704.

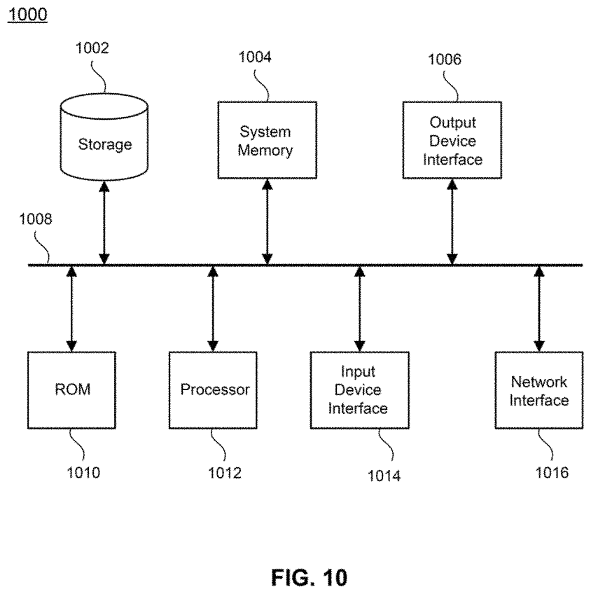

FIG. 10 conceptually illustrates an exemplary electronic system 1000 with which some implementations of the subject technology can be implemented. In one or more implementations, the computing device 102 and the tool control storage devices 106 may be, or may include all or part of, the electronic system components that are discussed below with respect to the electronic system 1000. The electronic system 1000 can be a computer, phone, personal digital assistant (PDA), or any other sort of electronic device. Such an electronic system includes various types of computer readable media and interfaces for various other types of computer readable media. The electronic system 1000 includes a bus 1008, processor(s) 1012, a system memory 1004, a read-only memory (ROM) 1010, a permanent storage device 1002, an input device interface 1014, an output device interface 1006, and a network interface 1016.

The bus 1008 collectively represents all system, peripheral, and chipset buses that communicatively connect the numerous internal devices of the electronic system 1000. For instance, the bus 1008 communicatively connects the processor(s) 1012 with the ROM 1010, system memory 1004, and permanent storage device 1002.

From these various memory units, the processor(s) 1012 retrieves instructions to execute and data to process in order to execute the processes of the subject disclosure. The processor(s) can be a single processor or a multi-core processor in different implementations.

The ROM 1010 stores static data and instructions that are needed by the processor(s) 1012 and other modules of the electronic system. The permanent storage device 1002, on the other hand, is a read-and-write memory device. This device is a non-volatile memory unit that stores instructions and data even when the electronic system 1000 is off. Some implementations of the subject disclosure use a mass-storage device (for example, a magnetic or optical disk, or flash memory) as the permanent storage device 1002.

Other implementations use a removable storage device (for example, a floppy disk, flash drive) as the permanent storage device 1002. Like the permanent storage device 1002, the system memory 1004 is a read-and-write memory device. However, unlike the storage device 1002, the system memory 1004 is a volatile read-and-write memory, such as a random access memory. The system memory 1004 stores some of the instructions and data that the processor needs at runtime. In some implementations, the processes of the subject disclosure are stored in the system memory 1004, the permanent storage device 1002, or the ROM 1010. For example, the various memory units include instructions for displaying graphical elements and identifiers associated with respective applications, receiving a predetermined user input to display visual representations of shortcuts associated with respective applications, and displaying the visual representations of shortcuts. From these various memory units, the processor(s) 1012 retrieves instructions to execute and data to process in order to execute the processes of some implementations.

The bus 1008 also connects to the input and output device interfaces 1014 and 1006. The input device interface 1014 enables the user to communicate information and select commands to the electronic system. Input devices used with the input device interface 1014 include, for example, alphanumeric keyboards and pointing devices (also called “cursor control devices”). The output device interface 1006 enables, for example, the display of images generated by the electronic system 1000. Output devices used with the output device interface 1006 include, for example, printers and display devices, for example, cathode ray tubes (CRT) or liquid crystal displays (LCD). Some implementations include devices, for example, a touchscreen that functions as both input and output devices.

Finally, as shown in FIG. 10, the bus 1008 also couples the electronic system 1000 to a network (not shown) through a network interface. In this manner, the computer can be a part of a network of computers (for example, a LAN, a WAN, or an Intranet, or a network of networks, for example, the Internet). Any or all components of the electronic system 1000 can be used in conjunction with the subject disclosure.

Many of the above-described features and applications are implemented as software processes that are specified as a set of instructions recorded on a computer readable storage medium (also referred to as computer readable medium). When these instructions are executed by one or more processor(s) (e.g., one or more processors, cores of processors, or other processing units), they cause the processor(s) to perform the actions indicated in the instructions. Examples of computer readable media include, but are not limited to, magnetic media, optical media, electronic media, etc. The computer readable media does not include carrier waves and electronic signals passing wirelessly or over wired connections.

Unless otherwise stated, all measurements, values, ratings, positions, magnitudes, sizes, and other specifications that are set forth in this specification are approximate, not exact. They are intended to have a reasonable range that is consistent with the functions to which they relate and with what is customary in the art to which they pertain.

Except as stated immediately above, nothing that has been stated or illustrated is intended or should be interpreted to cause a dedication of any component, step, feature, object, benefit, advantage, or equivalent to the public.

In this specification, the term “software” is meant to include, for example, firmware residing in read-only memory or other form of electronic storage, or applications that may be stored in magnetic storage, optical, solid state, etc., which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage, and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code including machine code, for example, produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this disclosure, the terms “computer”, “server”, “processor”, and “memory” all refer to electronic or other technological devices. These terms exclude people or groups of people. For the purposes of the specification, the terms display or displaying means displaying on an electronic device. As used in this disclosure, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Where reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

To the extent that the systems discussed herein collect usage data associated with users, or may make use of the usage data, the users are provided with opportunities to control whether programs or features collect usage data (e.g., a user's preferences), and to control the user interface (UI) associated with applications based on the collected usage data. The users may also be provided with options to turn on or turn off certain features or functions provided by the systems. In some aspects, the users may elect to disable features and functions (e.g., control the UI associated with applications based on the collected usage data) offered by the systems discussed herein. In addition, users may stipulate that certain data be treated in one or more ways before it is stored or used, so that personally identifiable information is removed. For example, a user's identity may be treated so that no personally identifiable information can be determined for the user, or a user's geographic location may be generalized where location information is obtained (such as to a city, zip code, or state level), so that a particular location of a user cannot be determined. Thus, the user has control over whether and how user information is collected, stored, and used by the disclosed systems.

An embodiment of the disclosure is an inventory control system that comprises an object storage device, one or more processors, a display device, and a mobile device. The object storage device includes a plurality of compartments, and each compartment includes a plurality of storage locations for storing objects. The one or more processors are configured to establish a database containing information regarding the object storage device, retrieve the information regarding the object storage device from the database, and generate an optical symbol based on the information regarding the object storage device. The display device is associated with the object storage device and configured to display the optical symbol. The mobile device is configured to capture an image of the optical symbol, obtain the information regarding the object storage device based on the image of the optical symbol, and display the information regarding the object storage device on a display screen of the mobile device.

In some embodiments, the optical symbol is one of a two-dimensional (2D) bar code, a Quick Response (QR) code, a portable data file 417 (PDF417), a Data Matrix, an Aztec Code, or a Maxi Code. In other embodiments, the database includes one or more of: instructions, procedures, images, messages, links, or data related to the function of a graphical user interface of the object storage device. In certain embodiments, the optical symbol is displayed on the display device in response to a user input. In some embodiments, the display device is further configured to receive input from a user, and the user input is received by the display device. In other embodiments, the one or more processors are further configured to generate a graphical user interface that includes a user-selectable element, and cause the display device to display the optical symbol when the user-selectable element is selected by a user of the object storage device. In certain embodiments, the one or more processors are further configured to generate the optical symbol prior to the user selection of the user-selectable element and based on system information and data that does not change over time, and store the optical symbol during an initial system set up and configuration of the object storage device. In some embodiments, the one or more processors are further configured to generate the optical symbol after the user selection of the user-selectable element and based on information obtained by a search of the database. In other embodiments, the inventory control system further comprises a second display device and a network. The second display device is remote from the object storage device and corresponds to an administrative application. The network is configured to transmit communications between the object storage device and the administrative application. In such embodiment, the one or more processors are configured to cause the optical symbol to be transmitted over the network to the administrative application for display on the second display, and the mobile device is configured to capture the image of the optical symbol at the second display. In some embodiments, the mobile device is further configured to generate a service request based on the information regarding the object storage device displayed on the display screen of the mobile device, and transmit the service request via a web-based application.

Another embodiment of the disclosure is a method. The method comprises establishing a database containing information regarding an object storage device. Then, the information regarding the object storage device form the database is retrieved. Subsequently, an optical symbol is generated based on the information regarding the object storage device. The optical symbol is then displayed on a display device associated with the object storage device. An image of the optical symbol is captured using a mobile device, and the information regarding the object storage device is obtained based on the image of the optical symbol. Finally, on a display screen of the mobile device, the information regarding the object storage device is displayed.

In some embodiments, the optical symbol is one of: a two-dimensional (2D) bar code, a Quick Response (QR) code, a portable data file 417 (PDF417), a Data Matrix, an Aztec Code, or a Maxi Code. In other embodiments, the database includes one or more of: instructions, procedures, images, messages, links, or data related to the function of a graphical user interface of the object storage device. In certain embodiments, the method further comprises the step of receiving a user input, in which the optical symbol is displayed on the display device in response to the user input. In some embodiments, the display device is further configured to receive input from a user, and the user input is received by the display device. In other embodiments, the method further comprises the step of generating a graphical user interface that includes a user-selectable element. In such embodiment, the display device displays the optical symbol after the user-selectable element is selected by a user of the object storage device. In certain embodiments, the step of generating the optical symbol is carried out prior to the user selection of the user-selectable element and is based on system information and data that does not change over time. The method further comprises the step of storing the optical symbol during an initial system set up and configuration of the object storage device. In some embodiments, the method comprises the step of generating the optical symbol is carried out after the user selection of the user-selectable element and is based on information obtained by a search of the database. In other embodiments, the inventory control system further comprises a second display device and a network. The second display device is remote from the object storage device and corresponding to an administrative application. The network is configured to transmit communications between the object storage device and the administrative application. The method further comprises the step of transmitting the optical symbol over a network to an administrative application and displaying the optical symbol on a second display device remote from the object storage device. In such embodiment, the mobile device captures the image of the optical symbol at the second display. In certain embodiments, the method further comprises the steps of generating a service request based on the information regarding the object storage device displayed on the display screen of the mobile device, and transmitting the service request via a web-based application.

All structural and functional equivalents to the elements of the various aspects described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. Furthermore, to the extent that the term “include”, “have”, or the like is used in the disclosure, such term is intended to be inclusive in a manner similar to the term “comprise” as “comprise” is interpreted.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

In the foregoing Description, it can be seen that various features are grouped together in various embodiments for the purpose of streamlining the disclosure.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended that this disclosure cover any and all applications, modifications and variations that fall within the true scope of the present teachings.

What is claimed is:

1. An inventory control system comprising:
an object storage device including a plurality of compartments, each compartment including a plurality of storage locations for storing objects;
one or more processors configured to:
establish a database containing information regarding the object storage device,
retrieve the information regarding the object storage device from the database, and
generate an optical symbol based on the information regarding the object storage device;
a display device associated with the object storage device and configured to display the optical symbol; and
a mobile device configured to:
capture an image of the optical symbol,
obtain the information regarding the object storage device based on the image of the optical symbol, and
display, on a display screen of the mobile device, the information regarding the object storage device.

2. The inventory control system of claim 1, wherein the optical symbol is one of: a two-dimensional (2D) bar code, a Quick Response (QR) code, a portable data file 417 (PDF417), a Data Matrix, an Aztec Code, or a Maxi Code.

3. The inventory control system of claim 1, wherein the database includes one or more of: instructions, procedures, images, messages, links, or data related to the function of a graphical user interface of the object storage device.

4. The inventory control system of claim 1, wherein the optical symbol is displayed on the display device in response to a user input.

5. The inventory control system of claim 4, wherein the display device is further configured to receive input from a user, and the user input is received by the display device.

6. The inventory control system of claim 1, wherein the one or more processors are further configured to:
generate a graphical user interface that includes a user-selectable element, and
when the user-selectable element is selected by a user of the object storage device, cause the display device to display the optical symbol.

7. The inventory control system of claim 6, wherein the one or more processors are further configured to:
generate the optical symbol prior to the user selection of the user-selectable element and based on system information and data that does not change over time, and
store the optical symbol during an initial system set up and configuration of the object storage device.

8. The inventory control system of claim 6, wherein the one or more processors are further configured to:
generate the optical symbol after the user selection of the user-selectable element and based on information obtained by a search of the database.

9. The inventory control system of claim 1, further comprising:
a second display device remote from the object storage device and corresponding to an administrative application; and
a network configured to transmit communications between the object storage device and the administrative application;
wherein the one or more processors are configured to cause the optical symbol to be transmitted over the network to the administrative application for display on the second display, and
wherein the mobile device is configured to capture the image of the optical symbol at the second display.

10. The inventory control system of claim 1, wherein the mobile device is further configured to:
generate a service request based on the information regarding the object storage device displayed on the display screen of the mobile device, and
transmit the service request via a web-based application.

11. A method comprising:
establishing a database containing information regarding an object storage device;
retrieving the information regarding the object storage device form the database;
generating an optical symbol based on the information regarding the object storage device;
displaying the optical symbol on a display device associated with the object storage device;
capturing an image of the optical symbol using a mobile device;
obtaining the information regarding the object storage device based on the image of the optical symbol; and
displaying, on a display screen of the mobile device, the information regarding the object storage device.

12. The method of claim 11, wherein the optical symbol is one of: a two-dimensional (2D) bar code, a Quick Response (QR) code, a portable data file 417 (PDF417), a Data Matrix, an Aztec Code, or a Maxi Code.

13. The method of claim 11, wherein the database includes one or more of: instructions, procedures, images, messages, links, or data related to the function of a graphical user interface of the object storage device.

14. The method of claim 11, further comprising the step of:
receiving a user input,
wherein the optical symbol is displayed on the display device in response to the user input.

15. The method of claim 14, wherein the display device is further configured to receive input from a user, and the user input is received by the display device.

16. The method of claim 11, further comprising the step of:
generating a graphical user interface that includes a user-selectable element,
wherein the display device displays the optical symbol after the user-selectable element is selected by a user of the object storage device.

17. The method of claim 16, wherein:
the step of generating the optical symbol is carried out prior to the user selection of the user-selectable element and is based on system information and data that does not change over time,
the method further comprising the step of:
storing the optical symbol during an initial system set up and configuration of the object storage device.

18. The method of claim 16, wherein:
the step of generating the optical symbol is carried out after the user selection of the user-selectable element and is based on information obtained by a search of the database.

19. The method of claim 11, further comprising the step of:
a second display device remote from the object storage device and corresponding to an administrative application; and
a network configured to transmit communications between the object storage device and the administrative application;
transmitting the optical symbol over a network to an administrative application; and
displaying the optical symbol on a second display device remote from the object storage device,
wherein the mobile device captures the image of the optical symbol at the second display.

20. The method of claim 11, further comprising the steps of:
generating a service request based on the information regarding the object storage device displayed on the display screen of the mobile device, and
transmitting the service request via a web-based application.
